(19) United States
(12) Patent Application Publication
(10) Pub. No.: US 2024/0255433 A1
(43) Pub. Date: Aug. 1, 2024

(54) APPARATUS AND METHOD FOR CALIBRATING MEASURING DEVICES FOR DLR MEASUREMENT WITH OPTOCHEMICAL PH SENSORS

(71) Applicant: PyroScience GmbH, Aachen (DE)

(72) Inventor: Christoph Staudinger, Aachen (DE)

(21) Appl. No.: 18/422,225

(22) Filed: Jan. 25, 2024

(30) Foreign Application Priority Data
Jan. 27, 2023 (DE) 102023200682.0

(51) Int. Cl. G01N 21/80

(52) U.S. Cl. CPC G01N 21/80; G01N 2201/127

(57) ABSTRACT

A device for calibrating measuring instruments for DLR measurement with optochemical pH sensors. The device includes a calibration head with a calibration layer applied to a carrier layer which contains a non-pH-sensitive dye which has the same optical properties as the pH-sensitive dye used for pH measurement, and the same reference dye as is used for pH measurement. Further including at least one light guide to the first end face of which the carrier layer with applied calibration layer is attached and the second end face of which is used to produce a light-conducting dye, as is used for the pH measurement, and at least one light guide, to the first end face of which the carrier layer with applied calibration layer is attached, and the second end face of which is set up to produce a light-conducting connection to a measuring device for DLR measurement with optochemical pH sensors.

### CROSS-REFERENCE TO RELATED APPLICATIONS

The subject patent application claims priority to, and all the benefits of, German Patent Application No DE 10 2023 200 682.0, filed on Jan. 27, 2023, the entire contents of which are incorporated by reference herein.

### BACKGROUND

Measurements with interchangeable sensors also require very good alignment between the measuring devices. Each measuring device must display the same value for a sensor. With ratiometric optochemical pH sensors, such as those used for DLR measurements, the biggest problem is the wavelength dependence of the measurement. The use of two different luminophores almost inevitably results in a wavelength dependency, as the absorption and emission spectra of two substances will never be exactly identical.

Due to cost, size and energy consumption, measuring devices for optochemical pH sensors are almost always realized with LEDs and optical filters. However, optical filters and LEDs in particular have fluctuations in their optical properties. The emission spectrum of LEDs is not monochromatic, but a peak around one wavelength. The position and shape of this peak varies between different LEDs.

In addition to the wavelength fluctuations, LEDs also exhibit a temperature dependence. The emission spectrum of an LED generally shifts to higher wavelengths at higher temperatures. The emission spectrum of the LED is also influenced by the applied current.

These wavelength fluctuations and temperature effects are particularly pronounced with red/NIR LEDs. However, red/NIR excitation is gentler on samples and is therefore preferable.

Due to these fluctuations, each measuring device has an individual excitation spectrum and an individual wavelength sensitivity. As ratiometric measurements are wavelength-dependent, each device initially measures different values.

This means that an individual calibration is normally required for each device plus sensor head combination prior to measurement.

This individual calibration is very difficult or impossible to realize for some applications. This applies in particular to single-use and high-throughput systems.

The method of DLR measurement with optochemical pH sensors is described, for example, in WO 99/06821 A1.

DE 10 2020 134 517 A1 describes a further development. This describes optochemical pH sensor elements which, in addition to a pH-sensitive dye and a reference dye, have a passivated pH-sensitive dye in order to enable drift compensation for the sensor element.

### SUMMARY

The invention relates to a device and a method for calibrating measuring devices for DLR measurement (DLR: Dual Lifetime Referencing) with optochemical pH sensors (optodes).

The task of the invention is to provide a device and a method for calibrating measuring devices for DLR measurement with optochemical pH sensors for one-time calibration of the measuring device, so that the measuring device can then be used with different sensor heads without recalibration.

According to the invention, this task is solved by a device with the features of independent claim 1. Advantageous further embodiments of the device are shown in subclaims 2 to 7. The problem is further solved by a method according to claim 8.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 schematically shows the structure of a device according to the invention for calibrating measuring devices for DLR measurement with optochemical pH sensors and their connection to a measuring device to be calibrated.

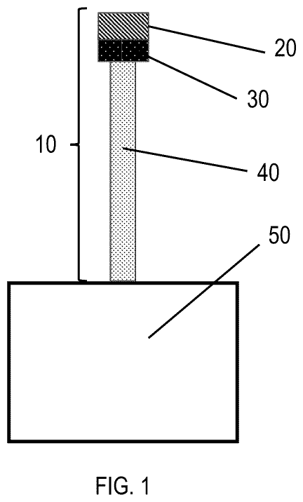

### DETAILED DESCRIPTION

The device according to the invention comprises a calibration head, which does not contain a pH-sensitive dye, which has a calibration layer applied to a carrier layer and at least one light guide, wherein to the first end face of the at least one light guide the carrier layer with applied calibration layer is attached, and wherein the second end face of the at least one light guide is set up to establish a light-conducting connection with a measuring device for DLR measurement with optochemical pH sensors.

It is essential to the invention that the calibration layer has a non-pH-sensitive dye as a standard for the calibration, which has the same optical properties as the pH-sensitive dye used for the pH measurement, and contains the same reference dye as is used for the pH measurement. The non-pH-sensitive dye and the reference dye are embedded in a matrix made of a polymer.

Preferably, the polymer matrix is a hydrophobic matrix that is impermeable to hydrogen ions. Preferred matrix materials are polysiloxanes, perfluoropolymers or polystyrenes. In one embodiment of the invention, the non-pH-sensitive dye used as a standard is obtained by embedding a pH-sensitive dye in a hydrophobic matrix of a polymer that is impermeable to hydrogen ions. In this embodiment, the matrix impermeable to hydrogen ions preferably consists essentially of a polystyrene.

In another preferred embodiment of the invention, the non-pH-sensitive dye is a dye obtained from a pH-sensitive dye by chemically blocking its groups reacting with hydrogen ions in a manner known per se. This is preferably done by converting the hydroxyl or amino groups of a pH-sensitive dye that react with hydrogen ions into esters, silyl ethers, ethers, or amides. pH-sensitive dyes suitable for such a reaction are known to the skilled person. According to the invention, it is particularly preferred to use as a non-pH-sensitive dye a derivative of a pH-sensitive dye which is used in sensor heads for optochemical pH measurement and whose groups reacting with hydrogen ions have been chemically blocked.

The calibration head according to the invention is produced by coating the carrier layer with the calibration layer containing the non-pH-sensitive dye and the reference dye. This is carried out by coating using conventional coating processes, preferably by spin coating, dispensing, screen printing or dip coating and in particular by doctor blade coating, a solution or dispersion of the dye serving as a non-pH-sensitive dye and the reference dye in a solution of the matrix material in a suitable solvent. Suitable solvents according to the invention are all solvents in which the polymers and the non-pH-sensitive dye and the reference dye are soluble or dispersible, in particular CHCl₃, toluene, THF, ethyl acetate or a mixture of ethanol and water. Depending on the matrix material, however, other solvents can also be used. After a drying step, sections are cut out of the resulting composite, preferably by punching, in the size required to produce a calibration head. These sensor elements are then glued or clamped to an end face of a light guide or attached to a holder or a cap, preferably by gluing, during the manufacture of the calibration head. The thickness of the calibration layer applied in this way corresponds to the usual layer thickness of the sensor layer used in optrodes for pH measurement and is preferably 0.5 μm to 100 μm and in particular 1 μm to 10 μm.

The carrier layer is a transparent, i.e., translucent film or a thin glass layer, preferably a transparent plastic film made of a non-water-absorbent plastic, in particular a film made of polyethylene terephthalate (PET), polyethylene naphthalate (PEN), polymethyl methacrylate (PMMA) or polystyrene (PS). The thickness of the carrier layer is preferably 10 μm to 1 mm, in particular 50 μm to 200 μm.

In order to also take into account the temperature dependence of the sensor element, the measurement must be carried out at a known temperature. Therefore, the device according to the invention must have a suitable device for setting and controlling the measuring temperature. Suitable devices are known to the skilled person.

The invention also relates to a method for calibrating measuring devices for DLR measurement with optochemical pH sensors. A calibration head as described above, which does not contain a pH-sensitive dye and comprises a calibration layer applied to a support layer, wherein the calibration layer contains a non-pH-sensitive dye which has the same optical properties as the pH-sensitive dye used for pH measurement and the same reference dye as used for pH measurement, as used for the pH measurement, and wherein for the calibration head the ratio of fluorescence to phosphorescence R_{std} has been determined on a calibrated measuring device for DLR measurement with optochemical pH sensors at one or more measuring temperatures for each measuring channel, is light-conductively connected to a measuring device to be calibrated for DLR measurement with optochemical pH sensors.

The phase angle of the pH-insensitive dye and the reference dye is then measured for each measuring channel at a defined measuring temperature using the measuring device to be calibrated and a ratio of fluorescence to phosphorescence R is calculated from this, from which the calibration factor F of the measuring device to be calibrated is then calculated using the formula F=R_{std}/R. The measurement method is described in detail in WO 99/06821 A1.

The embodiments shown here are only examples of the present invention and should therefore not be understood to be limiting. Alternative embodiments contemplated by the skilled person are equally encompassed by the scope of protection of the present invention.

Several instances have been discussed in the foregoing description. However, the aspects discussed herein are not intended to be exhaustive or limit the disclosure to any particular form. Various modifications to these aspects will be readily apparent to those skilled in the art, and the generic principles defined herein may be applied to other aspects without departing from the scope of the disclosure. The terminology that has been used is intended to be in the nature of words of description rather than of limitation. Many modifications and variations are possible in light of the above teachings and the disclosure may be practiced otherwise than as specifically described.

### LIST OF REFERENCE NUMERALS

10 Calibration head
20 Calibration layer
30 Support layer
40 Light guide
50 Measuring device

1. A device for calibrating measuring devices for DLR measurement with optochemical pH sensors, the device comprising:
a calibration head comprising a calibration layer applied to a carrier layer containing a non-pH-sensitive dye, wherein the non-pH-sensitive dye has the same optical properties as a pH-sensitive dye and the same reference dye as used for pH measurement, and wherein the calibration layer does not contain a pH sensitive dye; and
at least one light guide having a first face and a second face, wherein the carrier layer and the calibration layer are attached to the first face of the at least one light guide, and wherein the second face of the at least one light guide is configured to establish a light-conducting connection with a measuring device for DLR measurement with optochemical pH sensors.

2. The device for calibrating measuring devices for DLR measurement with optochemical pH sensors according to claim 1, wherein the non-pH-sensitive dye and the reference dye are embedded in a matrix of a polymer.

3. The device for calibrating measuring devices for DLR measurement with optochemical pH sensors according to claim 2, wherein the matrix of the polymer is a hydrophobic matrix which is impermeable to hydrogen ions.

4. The device for calibrating measuring devices for DLR measurement with optochemical pH sensors according to claim 3, wherein the non-pH-sensitive dye is obtained by embedding a pH-sensitive dye in a hydrophobic, hydrogen-ion-impermeable matrix consisting essentially of a polymer.

5. The device for calibrating measuring devices for DLR measurement with optochemical pH sensors according to claim 4, wherein the hydrophobic, hydrogen-ion-impermeable matrix which is impermeable to hydrogen ions consists essentially of polystyrene.

6. The device for calibrating measuring devices for DLR measurement with optochemical pH sensors according to claim 1, wherein the non-pH-sensitive dye is obtained from a pH-sensitive dye by chemical blocking of the groups reacting with hydrogen ions.

7. The device for calibrating measuring devices for DLR measurement with optochemical pH sensors according to claim 1, wherein the device has a device for setting and controlling the measuring temperature.

8. A method for the calibration of measuring devices for DLR measurement with optochemical pH sensors, the method comprising:
a) a calibration head which contains no pH-sensitive dye and comprises a calibration layer which is applied to a carrier layer and wherein the calibration layer contains a non-pH-sensitive dye which has the same optical properties as the pH-sensitive dye used for the pH measurement, and contains the same reference dye as is used for the pH measurement, and wherein for the calibration head the ratio of fluorescence to phosphorescence R_{std} and the temperature dependence of R_{std} has been determined on a calibrated measuring device for DLR measurement with optochemical pH sensors, is light-conductively connected to a measuring device to be calibrated for DLR measurement with optochemical pH sensors;
b) a phase angle of the pH-insensitive dye and the reference dye and simultaneously the temperature during the measurement are set by means of the measuring device to be calibrated and a ratio of fluorescence to phosphorescence R is calculated therefrom; and
c) a calibration factor F of the measuring device to be calibrated is calculated according to the formula F=R_{std}/R.

9. A method for the calibration of measuring devices for DLR measurement with optochemical pH sensors, the method comprising:
light-conductively connecting a calibration head to a measuring device to be calibrated for DLR measurement with optochemical pH sensors, wherein the calibration head comprises a calibration layer applied to a carrier layer containing a non-pH-sensitive dye having the same optical properties as a pH-sensitive dye used for pH measurement and the same reference dye used for pH measurement, and wherein a ratio of fluorescence to phosphorescence R_{std} and a temperature dependence of R_{std} for the calibration head has been determined on a calibrated measuring device for DLR measurement with optochemical pH sensors;
setting by means of the measuring device to be calibrated a phase angle of the non-pH-sensitive dye and the reference dye and simultaneously a temperature during the measurement, and calculating a ratio of fluorescence to phosphorescence R; and
calculating a calibration factor F of the measuring device to be calibrated according to the formula F=R_{std}/R.
